(19) United States
(12) Patent Application Publication
(10) Pub. No.: US 2020/0159834 A1
(43) Pub. Date: May 21, 2020

(54) SYSTEMS AND METHODS OF PROCESSING TRANSACTION DATA

(71) Applicant: Wealthsimple Inc., Toronto (CA)

(72) Inventors: Usman Ismail, Toronto (CA); Marc Duez, Toronto (CA)

(21) Appl. No.: 16/192,463

(22) Filed: Nov. 15, 2018

(51) Int. Cl. G06F 17/30

(52) U.S. Cl. CPC G06F 17/30002; G06F 17/30946; G06F 17/30979; G06F 17/30991

(57) ABSTRACT

Methods and associated systems for managing large-scale transaction data are disclosed herein. An example method involves: receiving transaction data associated with each database-update transaction; assigning a transaction key to each transaction; storing the transaction data in association with the transaction key; determining metrics resulting from each transaction; for each metric, identifying affected states based on the affected state type; generating an updated state for each affected state based on the state change; storing each updated state in association with the transaction key of the transaction resulting in the updated state; receiving a transaction query; searching for an initial marker transaction and an end marker transaction; for each transaction assigned a transaction key between the initial marker transaction to, and including, the end marker transaction, retrieving a latest state generated based on a state change taking place within the predefined period; and generating the transaction report.

### FIELD

The described embodiments relate to managing large volume of transactions and processing transaction data to generate transaction reports in respect of the transactions.

### BACKGROUND

Large volumes of electronic transactions can be difficult to manage efficiently. Many electronic data systems process large volumes of transactions throughout a day. Each transaction consumes processing power and requires processing time. The effect of the transactions could affect existing state(s) managed by the electronic data systems, or could be delayed or retroactive. In order to obtain an accurate representation of the various states managed by the electronic data systems at any one time, the electronic data system may need to be taken offline or the states may be approximated instead.

### SUMMARY

The various embodiments described herein generally relate to methods (and associated systems configured to implement the methods) for managing large-scale transaction data. Some of the various embodiments described herein generally relate to methods (and associated systems configured to implement the methods) for generating transaction reports related to the large-scale transaction data for a predefined period.

In accordance with an embodiment, there is provided a method of operating a management processor to generate a transaction report for a predefined period. The method involves: receiving a set of transaction data associated with each transaction of a plurality of database-update transactions; assigning a transaction key to each transaction, each transaction key comprising an ordered value; storing, in a transaction database accessible by the management processor, the set of transaction data associated with each transaction and in association with the assigned transaction key; determining one or more metrics resulting from each transaction, each metric defining a state change to an affected state associated with an affected state type; for each metric: identifying one or more affected states based on the affected state type defined by the respective metric, the one or more affected states being associated with a respective state type corresponding to the affected state type defined by the respective metric; generating an updated state for each affected state based on the state change; and storing, in the transaction database, each updated state in association with the transaction key assigned to the respective transaction resulting in the updated state; receiving a transaction query defining a set of report parameters for the transaction report, the set of report parameters comprising a start date and an end date of the predefined period; searching, in the transaction database, for an initial marker transaction based on the start date and an end marker transaction based on the end date, the initial marker transaction corresponding to a transaction assigned a last transaction key for a day preceding the start date and the end marker transaction corresponding to a transaction assigned a last transaction key for the end date; for each transaction assigned a transaction key between a transaction key of the initial marker transaction to, and including, a transaction key of the end marker transaction, retrieving a latest state generated based on a state change taking place within the predefined period; and generating the transaction report based at least on the retrieved latest states.

In some embodiments, the ordered value is reflective of an execution time of the respective transaction.

In some embodiments, assigning the transaction key to each transaction involves: assigning a first transaction key to a first transaction of the plurality of database-update transactions; and assigning a second transaction key to a second transaction occurring subsequent to the first transaction, wherein a value of the second transaction key is subsequent to a value of the first transaction key.

In some embodiments, storing each updated state in association with the transaction key assigned to the respective transaction involves: storing the updated state as a version of one or more states previously stored in association with the transaction key.

In some embodiments, storing each updated state in association with the transaction key assigned to the respective transaction involves: storing an update time in association with the updated state to indicate when the updated state was updated.

In some embodiments, storing each updated state in association with the transaction key assigned to the respective transactions resulting in the state change to the updated state involves: storing an update time in association with the respective updated state, the update time indicating when the updated state was updated.

In some embodiments, generating the updated state for each affected state based on the state change involves: determining whether an effective time for the state change has passed; and in response to determining the effective time for the state change has passed, generating the updated state, otherwise, delaying the state change to each affected state until the effective time has passed.

In some embodiments, delaying the state change to each affected state until the effective time has passed involves: monitoring for a passing of the effective time; and generating the updated state when the effective time has passed.

In accordance with an embodiment, there is provided a system of generating a transaction report for a predefined period. The system involves: a transaction database for storing transaction data related to a plurality of database-update transactions; a management processor operable to: receive a set of transaction data associated with each transaction of the plurality of database-update transactions; assign a transaction key to each transaction, each transaction key comprising an ordered value; store, in the transaction database, the set of transaction data associated with each transaction and in association with the assigned transaction key; determine one or more metrics resulting from each transaction, each metric defining a state change to an affected state associated with an affected state type; for each metric: identify one or more affected states based on the affected state type defined by the respective metric, the one or more affected states being associated with a respective state type corresponding to the affected state type defined by the respective metric; generate an updated state for each affected state based on the state change; and store, in the transaction database, each updated state in association with the transaction key assigned to the respective transaction resulting in the updated state; receive a transaction query defining a set of report parameters for the transaction report, the set of report parameters comprising a start date and an end date of the predefined period; search, in the transaction database, for an initial marker transaction based on the start date and an end marker transaction based on the end date, the initial marker transaction corresponding to a transaction assigned a last transaction key for a day preceding the start date and the end marker transaction corresponding to a transaction assigned a last transaction key for the end date; for each transaction assigned a transaction key between a transaction key of the initial marker transaction to, and including, a transaction key of the end marker transaction, retrieve a latest state generated based on a state change taking place within the predefined period; and generate the transaction report based at least on the retrieved latest states.

In some embodiments, the ordered value is reflective of an execution time of the respective transaction.

In some embodiments, the management processor is operated to: assign a first transaction key to a first transaction of the plurality of database-update transactions; and assign a second transaction key to a second transaction occurring subsequent to the first transaction, wherein a value of the second transaction key is subsequent to a value of the first transaction key.

In some embodiments, the management processor is operable to: store the updated state as a version of one or more states previously stored in association with the transaction key.

In some embodiments, the management processor is operable to: store an update time in association with the updated state to indicate when the updated state was updated.

In some embodiments, the management processor is operable to: store an update time in association with the respective updated state, the update time indicating when the updated state was updated.

In some embodiments, the management processor is operable to: determine whether an effective time for the state change has passed; and in response to determining the effective time for the state change has passed, generate the updated state, otherwise, delay the state change to each affected state until the effective time has passed.

In some embodiments, the management processor is operable to: monitor for a passing of the effective time; and generate the updated state when the effective time has passed.

In accordance with an embodiment, there is provided a method of operating a management processor to selectively retrieve data from a plurality of database-update transactions, each transaction having a metric capable of affecting one or more states generated by the management processor. The method involves: assigning a transaction key to each transaction, each transaction key comprising an ordered value; storing, in a transaction database accessible by the management processor and in association with the assigned transaction key, a set of transaction data associated with each transaction; determining one or more metrics resulting from each transaction, each metric defining a state change to an affected state associated with an affected state type; and for each metric: identifying one or more affected states based on the affected state type defined by the respective metric, the one or more affected states being associated with a respective state type corresponding to the affected state type defined by the respective metric; generating an updated state for each affected state based on the state change; and storing, in the transaction database, each updated state in association with the transaction key assigned to the respective transaction resulting in the updated state.

In some embodiments, the ordered value is reflective of an execution time of the respective transaction.

In some embodiments, assigning the transaction key to each transaction involves: assigning a first transaction key to a first transaction of the plurality of database-update transactions; and assigning a second transaction key to a second transaction occurring subsequently to the first transaction, wherein a value of the second transaction key is subsequent to a value of the first transaction key.

In some embodiments, storing each updated state in association with the transaction key assigned to the respective transactions involves: storing the updated state as a version of one or more states previously stored in association with the transaction key.

In some embodiments, storing each updated state in association with the transaction key assigned to the respective transaction involves: storing an update time in association with the updated state to indicate when the updated state was updated.

In some embodiments, storing each updated state in association with the transaction key assigned to the respective transactions resulting in the state change to the updated state involves: storing an update time in association with the respective updated state, the update time indicating when the updated state was updated.

In some embodiments, generating the updated state for each affected state based on the state change involves: determining whether an effective time for the state change has passed; and in response to determining the effective time for the state change has passed, generating the updated state, otherwise, delaying the state change to each affected state until the effective time has passed.

In some embodiments, delaying the state change to each affected state until the effective time has passed involves: monitoring for a passing of the effective time; and generating the updated state when the effective time has passed.

In accordance with an embodiment, there is provided a system of selectively retrieving data from a plurality of database-update transactions. The system involves: a transaction database for storing transaction data associated with the plurality of database-update transactions; and a management processor operable to: assign a transaction key to each transaction, each transaction having a metric capable of affecting one or more states generated by the management processor and each transaction key comprising an ordered value; store, in the transaction database and in association with the assigned transaction key, a set of transaction data associated with each transaction; determining one or more metrics resulting from each transaction, each metric defining a state change to an affected state associated with an affected state type; and for each metric: identifying one or more affected states based on the affected state type defined by the respective metric, the one or more affected states being associated with a respective state type corresponding to the affected state type defined by the respective metric; generating an updated state for each affected state based on the state change; and storing, in the transaction database, each updated state in association with the transaction key assigned to the respective transaction resulting in the updated state.

In some embodiments, the ordered value is reflective of an execution time of the respective transaction.

In some embodiments, the management processor is operable to: assign a first transaction key to a first transaction of the plurality of database-update transactions; and assign a second transaction key to a second transaction occurring subsequently to the first transaction, wherein a value of the second transaction key is subsequent to a value of the first transaction key.

In some embodiments, the management processor is operable to: store the updated state as a version of one or more states previously stored in association with the transaction key.

In some embodiments, the management processor is operable to: store an update time in association with the updated state to indicate when the updated state was updated.

In some embodiments, the management processor is operable to: store an update time in association with the respective updated state, the update time indicating when the updated state was updated.

In some embodiments, the management processor is operable to: determine whether an effective time for the state change has passed; and in response to determining the effective time for the state change has passed, generate the updated state, otherwise, delay the state change to each affected state until the effective time has passed.

In some embodiments, the management processor is operable to: monitor for a passing of the effective time; and generate the updated state when the effective time has passed.

In accordance with an embodiment, there is provided a method of operating a management processor to generate a transaction report for a predefined period. The method involves: receiving a set of transaction data associated with each transaction of a plurality of database-update transactions; assigning a transaction key to each transaction, each transaction key comprising an ordered value; storing, in a transaction database accessible by the management processor, the set of transaction data associated with each transaction and in association with the assigned transaction key; receiving a transaction query defining a set of report parameters for the transaction report, the set of report parameters comprising a start date and an end date of the predefined period; searching, in the transaction database, for an initial marker transaction based on the start date and an end marker transaction based on the end date, the initial marker transaction corresponding to a transaction assigned a last transaction key for a day preceding the start date and the end marker transaction corresponding to a transaction assigned a last transaction key for the end date; for each transaction assigned a transaction key between a transaction key of the initial marker transaction to, and including, a transaction key of the end marker transaction, retrieving a latest state generated based on a state change taking place within the predefined period; and generating the transaction report based at least on the retrieved latest states.

In accordance with an embodiment, there is provided a system of generating a transaction report for a predefined period. The system involves: a transaction database for storing transaction data associated with a plurality of database-update transactions; a management processor operable to: receive a set of transaction data associated with each transaction of the plurality of database-update transactions; assign a transaction key to each transaction, each transaction key comprising an ordered value; store, in the transaction database, the set of transaction data associated with each transaction and in association with the assigned transaction key; receive a transaction query defining a set of report parameters for the transaction report, the set of report parameters comprising a start date and an end date of the predefined period; search, in the transaction database, for an initial marker transaction based on the start date and an end marker transaction based on the end date, the initial marker transaction corresponding to a transaction assigned a last transaction key for a day preceding the start date and the end marker transaction corresponding to a transaction assigned a last transaction key for the end date; for each transaction assigned a transaction key between a transaction key of the initial marker transaction to, and including, a transaction key of the end marker transaction, retrieve a latest state generated based on a state change taking place within the predefined period; and generate the transaction report based at least on the retrieved latest states.

### BRIEF DESCRIPTION OF THE DRAWINGS

Several embodiments will now be described in detail with reference to the drawings, in which:

FIG. 1 is a block diagram of components interacting with a transaction management system in accordance with an example embodiment;

FIG. 2 is a flowchart of an example embodiment of various methods of operating a management processor to generate a transaction report for a predefined period;

FIG. 3 is a schematic illustrating several transactions within an example time period in accordance with an embodiment;

FIG. 4 is an example transaction report in accordance with an embodiment;

FIG. 5 is a flowchart of another example embodiment of various methods of operating a management processor to generate a transaction report for a predefined period; and

FIG. 6 is a flowchart of an example embodiment of various methods of selectively retrieving data from a plurality of database-update transactions.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to methods (and associated systems configured to implement the methods) for managing large volumes of transactions and generating transaction reports in respect of those transactions.

Electronic data systems that process a large volume of transactions face various challenges when conducting those transactions and working with the transaction data that results from those transactions.

Managing large volumes of transaction data is computationally expensive and time consuming. To obtain a state of a transaction account, the electronic data system needs to query one or more databases for all transactions related to the transaction account since the transaction account was opened. This is important as each transaction can generate metrics that can affect different state types of the transaction account, and at different times. From the returned transactions, the electronic data system can then identify the transactions that affect the state types of interest. The electronic data system can then aggregate the impacts of each identified transaction to determine an updated state, if applicable, for the transaction account. Operating the electronic data system to conduct these operations can typically take several seconds for each transaction account. For electronic data systems that manage a large volume of transaction accounts, these operations can take many hours and consume a significant processing load at the database servers. In electronic wealth management data systems, for example, the process of determining a state of financial assets, such as a balance of the cash or equities, can be computationally expensive and slow. The operations required to determine the metrics that affect the relevant state types can take several hours.

During the computation time, the electronic data systems can continue to receive new transactions and those new transactions can affect existing states. In many electronic data systems, the effect(s) of each transaction can be important to track in order to account for each modification of a state. For example, electronic wealth management data systems often generate daily reports in respect of the cash and asset positions of each account, and the transactions that varied one or more states on that day. To generate those reports, it is critical that the electronic wealth management data systems have access to various details of the relevant transactions and states, such as when the transactions were processed, when a state was determined, and which transactions resulted in the modification to that state.

Also, the details in respect of how each transaction affects a particular state can be important when the electronic data systems generate reports for a specific time period. To generate reports for the specific time period, the electronic data systems need to determine the states ending in that time period. In order to do so, the electronic data systems need to be able to retrieve the information regarding how each transaction affects each state and when that effect took place. That is, all states managed by the electronic data systems needs to be derivable from prior states and applying the relevant transactions to result in the final state for that specific time period. Unfortunately, deriving the final state based on prior states and the relevant transactions can still be computationally intensive and error prone as multiple transactions can occur nearly simultaneously.

One option for electronic data systems to accurately determine a state could involve pausing the processing of all transactions while the electronic data systems compute the states. This option ensures that the transactions that are applied to determine the states are static while the state is determined. However, this renders the electronic data system to become out-of-service for long periods of time each day. Also, this option limits the scalability of the electronic data system since, as more accounts become supported by the electronic data system, the system down time needed to determine the states will increase as well.

Herein, systems and methods of managing large-scale transaction data, and for generating transaction reports related to the large-scale transaction data, are disclosed.

The systems and methods involve assigning a transaction key to each transaction. The transaction key can be unique. The transaction key can also represent an order in which transactions are received by the disclosed system. For example, the transaction key can be monotonically increasing so that a later processed transaction is assigned a transaction key having a greater value. The transaction keys can have strict ordering between the transactions.

Any updated states resulting from a transaction is also determined by the disclosed systems. The disclosed systems can store each version of the states along with information on how that state resulted. As will be described, the various stored states and their versions can be retrieved by the disclosed systems. This can minimize the computation load on the electronic data systems.

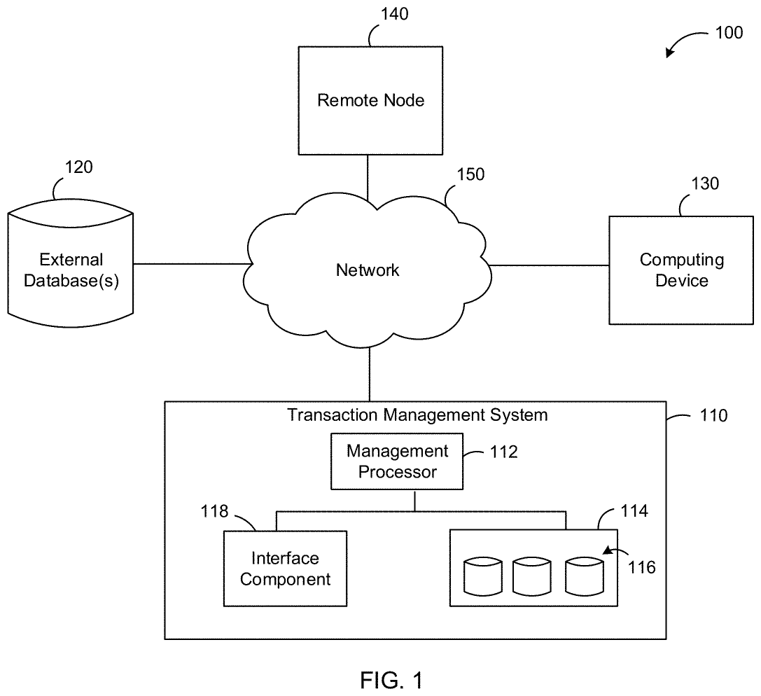

Referring now to FIG. 1, which illustrates a block diagram 100 of components interacting with a transaction management system 110. The transaction management system 110 can be in communication with one or more external databases 120, a computing device 130, and a remote node 140 via a network 150.

The computing device 130 may be any networked device operable to connect to the network 150. A networked device may couple to the network 150 through a wired or wireless connection. Although only one computing device 130 is shown, there may be multiple computing devices 130 distributed over a wide geographic area and connected via the network 150.

The computing device 130 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The network 150 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the computing device 130, the remote node 140, the external databases 120 and the transaction management system 110.

The transaction management system 110, the computing device 130, the remote node 140 and the external database 120 may connect to the network 150 or a portion thereof via suitable network interfaces.

The remote node 140 can include networked equipment, a software-as-a-service server (SaaS server) and/or other computing system (with at least a processor, a memory and a network interface) for receiving the notifications generated by the transaction management system 110. In some embodiments, the remote node 140 can include one or more computing systems operable by the transaction management system 110 to perform some or all of an operation defined within the action definition. Although only one remote node 140 is shown, there may be multiple remote nodes 140 distributed over a wide geographic area and connected via the network 150.

An example networked equipment can include an industrial machine, facilities equipment, sensor, or any other machine that can be connected to the network 150. The networked equipment can include a processor, such as a microcontroller, a memory that may include volatile and non-volatile elements, and at least one network interface. The networked equipment may include additional input or output devices, in some embodiments.

Like the networked equipment, the SaaS server has a processor, volatile and non-volatile memory, at least one network interface, and may have various other input/output devices. In many cases, the SaaS server may be constructed from a server farm, which may be in geographically diverse locations, and accessed via a load balancer. Such arrangements are sometimes referred to as “cloud” services. In general, the SaaS server provides one or more software applications, and may be accessed by one or more device from within the network 150 and occasionally from outside of network 150.

In some embodiments, a computing instance can be initiated by the transaction management system 110 for each account, and the computing instance can be at one or more remote nodes 140. For example, the computing instance can be a virtual machine instantiated at the remote nodes 140. The remote nodes 140 can serve as distributed computing resources for the transaction management system 110, which can reduce the computing load at the transaction management system 110.

As used herein, the term “software application” or “application” refers to computer-executable instructions, particularly computer-executable instructions stored in a non-transitory medium, such as a non-volatile memory, and executed by a processor. The processor, when executing the instructions, may receive inputs and transmit outputs to any of a variety of input or output devices to which it is coupled. Within an organization, a software application may be recognized by a name by both the people who use it, and those that supply or maintain it. A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs. For example, for many organizations, important applications and services rely on regular input from spreadsheets that may be obtained from third parties, so these spreadsheets may be identified as software applications.

The external database 120 can act as a back-up database for the data stored in a memory 114 of the transaction management system 110, and/or storing data that may not be as frequently used.

The transaction management system 110 includes a management processor 112, an interface component 118 and a memory 114. The management processor 112, the interface component 118 and the memory 114 can communicate with each other. The memory 114, as shown, can include one or more databases 116. Although only one transaction management system 110 is shown in FIG. 1, there may be multiple transaction management systems 110 distributed over a wide geographic area and connected via the network 150. Also, the transaction management system 110 is shown as one element but it is possible for its components to be distributed over a wide geographic area and connected via the network 150.

In some embodiments, each of the management processor 112, the interface component 118, and the memory 114 may be combined into a fewer number of components or may be separated into further components. The management processor 112, the interface component 118, and the memory 114 may be implemented in software or hardware, or a combination of software and hardware.

The management processor 112 may be any suitable processors, controllers or digital signal processors that can provide sufficient processing power depending on the configuration, purposes and requirements of the transaction management system 110. In some embodiments, the management processor 112 can include more than one processor with each processor being configured to perform different dedicated tasks.

The management processor 112 can be configured to control the operation of the transaction management system 110. The management processor 112 can initiate and manage the operations of each of the interface component 118 and the memory 114.

The interface component 118 may be any interface that enables the transaction management system 110 to communicate with other devices and systems. In some embodiments, the interface component 118 can include at least one of a serial port, a parallel port or a USB port. The interface component 118 may also include at least one of an Internet, Local Area Network (LAN), Ethernet, Firewire, modem or digital subscriber line connection. Various combinations of these elements may be incorporated within the interface component 118.

For example, the interface component 118 may receive input from various input devices, such as a mouse, a keyboard, a touch screen, a thumbwheel, a track-pad, a track-ball, a card-reader, voice recognition software and the like depending on the requirements and implementation of the transaction management system 110.

The memory 114 can include RAM, ROM, one or more hard drives, one or more flash drives or some other suitable data storage elements such as disk drives, etc. The memory 114 can be used to store an operating system and software applications. For instance, the operating system can provide various basic operational processes. The programs can include various user programs so that a user can interact with the interface component 118 to perform various functions such as, but not limited to, viewing and/or responding to the notifications generated by the transaction management system 110.

The memory 114 can store data related to the accounts associated with the transaction management system 110, for example. The accounts can relate to a user, and/or a specific product or project whose state is being managed by the transaction management system 110. For example, an account can be associated with a storage facility in which inventories of supplies are managed or an investment account.

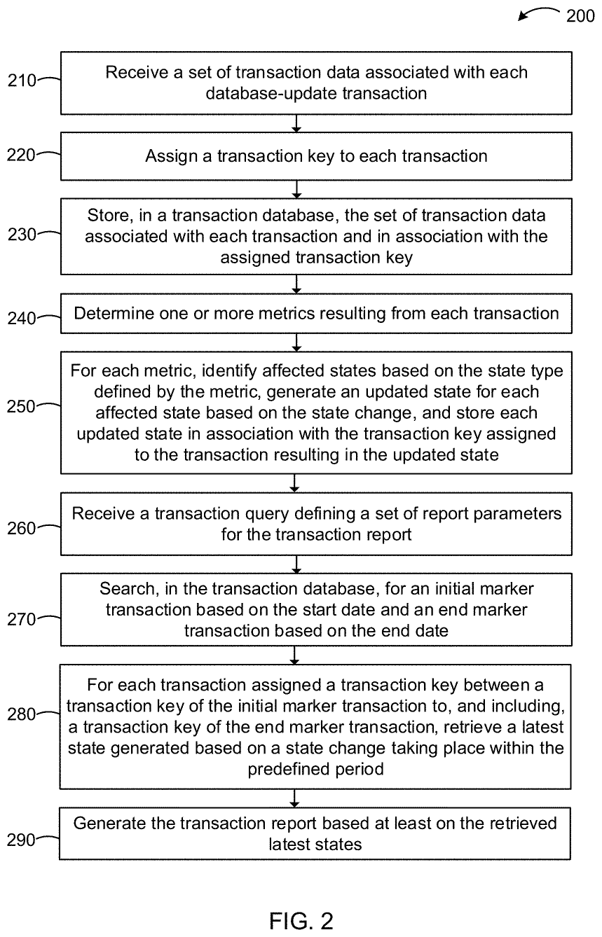

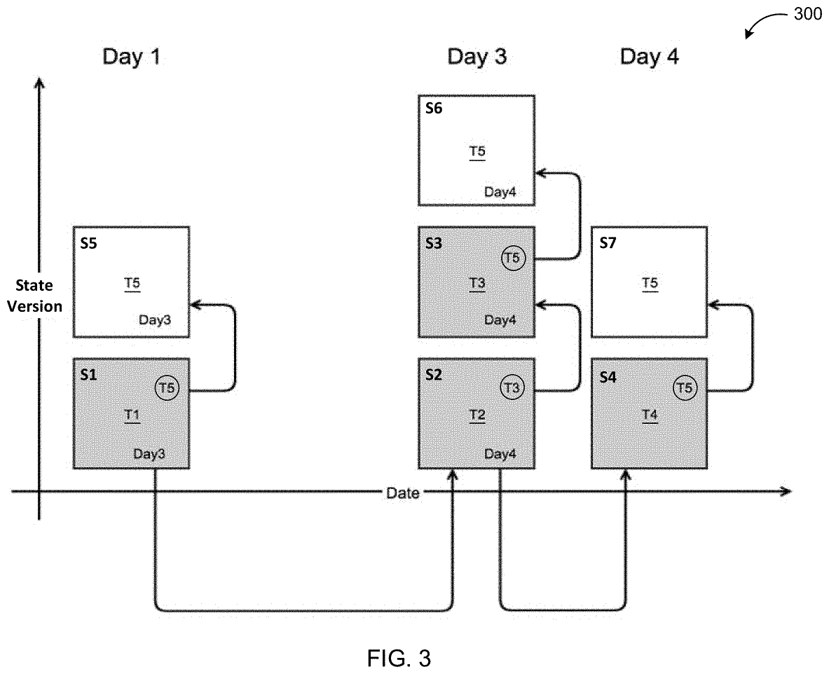

Reference will now be made to FIGS. 2 and 3 for describing an example method of operating the management processor 112 to generate a transaction report for a predefined time period. FIG. 2 is a flowchart of the method 200 and FIG. 3 shows a schematic 300 of several example transactions within the predefined time period.

At 210, the management processor 112 receives a set of transaction data associated with each database-update transaction.

The management processor 112 can process multiple database-update transactions at any one time. Each database-update transaction can cause an update to one or more states managed by the transaction management system 110. It is possible for the database-update transactions to generate new states, in some embodiments. One transaction can cause one or more states to be updated.

The transaction data can include various information about the transaction, such as an account affected by the transaction, a type of metric being affected by the transaction, an effective date on which the effect is effective, an end date on which the effect is no longer effective, and/or the time when the transaction was processed.

In FIG. 3, five different transactions, namely transaction T1, transaction T2, transaction T3, transaction T4, and transaction T5, are illustrated.

At 220, the management processor 112 assigns a transaction key to each transaction.

Each transaction key can include an ordered value. The ordered value can reflect an execution time of the respective transaction. For example, the management processor 112 can assign a first transaction key to a first transaction and a second transaction key to a second transaction that occurs subsequent to the first transaction. The value of the second transaction key can be subsequent to a value of the first transaction key. The ordered value can, in some embodiments, be monotonically increasing for each subsequently occurring transaction.

In the example shown in FIG. 3, the management processor 112 can assign a transaction key “T1” to transaction T1, a transaction key “T2” to transaction T2, a transaction key “T3” to transaction T3, a transaction key “T4” to transaction T4, and a transaction key “T5” to transaction T5. These example transaction keys, therefore, can represent that transaction T1 was executed prior to transactions T2 to T5, transaction T2 was executed prior to transactions T3 to T5, transaction T3 was executed prior to transactions T4 to T5, and transaction T4 was executed prior to transaction T5.

At 230, the management processor 112 stores, in a transaction database 116 accessible by the management processor 112, the set of transaction data associated with each transaction and in association with the assigned transaction key.

At 240, the management processor 112 determines one or more metrics resulting from each transaction.

A metric can define a state change to a state of a specific state type. The metric can identify the affected state types based on the metric, and the management processor 112 can then identify the one or more states affected by the metric. In a wealth management system, example state types can include, but is not limited to, cash or asset. For example, in a wealth management system, a cash deposit transaction of $10 can result in a state change of an increase in $10.

The metric can also include information in respect of a start date on which the state change is effective, an end date to the state change, an account affected by the metric, a value of the state change, a start transaction that resulted in the metric, an end transaction that causes the metric to no longer be effective, and the transaction key of the transaction.

It is possible for the metric to not have an end date. The end date may be null if there is no known state change to the affected states. If there are no further updates to the affected state, it is possible for the metric to not have an end transaction.

The metric can also be characterized by a metric type, such as a quantity amount or book value, for example.

At 250, for each metric, the management processor 112 identifies one or more affected states based on the affected state type defined by the respective metric.

A transaction can result in multiple metrics. For example, in a wealth management system, an asset sale transaction can result in a metric related to an asset balance (i.e., a decrease in an asset balance) and a cash balance (i.e., an increase in a cash balance).

The management processor 112 applies the metric to the affected states on the effective date to generate an updated state based on the state change. The management processor 112 can add the state change value to the affected state, in some embodiments.

The management processor 112 stores the updated states in association with the transaction key of the transaction that resulted in the updated state in the transaction database 116. The management processor 112 can also store an update time with the updated state to indicate when the updated state was updated. The management processor 112 can store the updated state as a version of the state(s) previously stored in the transaction database 116.

In the example shown in FIG. 3, the management processor 112 processed transaction T1 on Day 1 and determined that the metric resulting from transaction T1 had Day 3 as an end date. Transaction T1 also caused a state change that generated an updated state, or a first state version S1. With Day 3 as the end date, the management processor 112 can determine that any transactions that take place after Day 3 can affect the first state version S1.

On Day 3, the management processor 112 receives transaction data in respect of transaction T2 and determines that transaction T2 results in a metric that has an end date of Day 4. The management processor 112 also updates the first state version S1 to generate a second state version S2 based on the state change defined by the metric resulting from the transaction T2.

Following transaction T2, the management processor 112 receives transaction data in respect of transaction T3. The management processor 112 assigns a transaction key to the transaction T2 and a transaction key to the transaction T3 so that the T2 transaction key precedes the T3 transaction key since the transaction T3 occurs subsequent to the transaction T2. The management processor 112 determines that transaction T3 also results in a metric that has an end date of Day 4 and also defines a state change. Since transactions T2 and T3 occur on the same day, the management processor 112 designates the transaction T3 as the end transaction of the transaction T2 since the effect of the transaction T3 is determinative for Day 3. The management processor 112 applies the state change defined by the metric resulting from the transaction T3 to the second state version S2 to generate a third state version S3.

On Day 4, the management processor 112 receives transaction data in respect of transaction T4 and determines that transaction T4 results in a metric that updates the third state version S3. The management processor 112 then applies the state change defined by the metric to generate a fourth state version S4.

Also on Day 4, the management processor 112 receives transaction data in respect of transaction T5. Although the transaction T5 occurred subsequent to the transactions T1 to T4, the transaction T5 has an effective date since Day 1. The management processor 112 then applies the state change defined by the metric resulting from the transaction T5 to the state version S1 on Day 1 to generate an updated state version S5, to the state version S3 on Day 3 to generate an updated state version S6, and to the state version S4 on Day 4 to generate an updated state version S7.

In some embodiments, the effective time for a state change resulting from a transaction can be a time in the future. The management processor 112 can determine whether the effective time for a state change has passed. When the management processor 112 determines that the effective time for the state change has passed, the management processor 112 can generate the updated state based on the state change. When the management processor 112 determines that the effective time for the state change has not passed, the management processor 112 can monitor for the passing of the effective time and delay the state change until the effective time has passed.

At 260, the management processor 112 receives a transaction query that defines a set of report parameters for the transaction report.

The set of report parameters includes a start date and an end date of the predefined period. With respect to the example shown in FIG. 3, the management processor 112 can receive a transaction query for a transaction report for the transactions and resulting states during any of the period from Day 1 to Day 4. As each state version is stored in the transaction database 116, and/or external database 120, the management processor 112 can retrieve the relevant state version for the time period defined by the transaction query.

For example, the management processor 112 can receive a transaction query for the state for Day 1 to Day 3. The management processor 112 retrieves the state S1 resulting from the transaction T1 and the state S3 resulting from the transaction T3 instead of the states S5 and S6 resulting from the transaction T5 since the transaction T5 took place on Day 4.

The management processor 112 can also identify the specific transactions that resulted in the relevant state version, which can, in some embodiments, be important for improving the auditability of the transactions processed by the management processor 112.

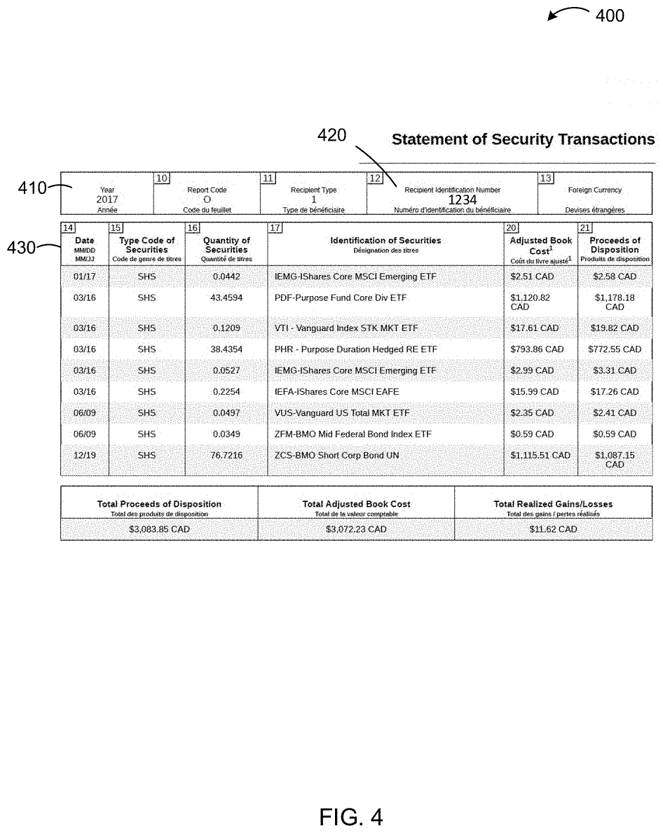

FIG. 4 shows an example transaction report 400 for the predefined period 410 (i.e., year 2017) and for account associated with account identifier 420 (“1234”). The data related to the relevant transactions are shown generally at 430. Transaction report 400 is only an example. Other transaction reports for different report parameters, such as, but not limited to, different lengths of time periods, accounts and/or types of transactions can be generated by the methods and systems described herein.

At 270, the management processor 112 searches, in the transaction database 116, for an initial marker transaction based on the start date and an end marker transaction based on the end date.

The initial marker transaction corresponds to a transaction assigned a last transaction key for a day preceding the start date and the end marker transaction corresponds to a transaction assigned a last transaction key for the end date. As each transaction is assigned a transaction key with an ordered value, by limiting the search query to transactions assigned a transaction key between the initial marker transaction and the end marker transaction, the management processor 112 can generate the requested transaction report with minimal to no effect on the processing of the incoming transactions.

For example, in response to a transaction query for the state on Day 3, the management processor 112 can assign transaction T1 as the initial marker transaction since no transaction took place on day 2, and the transaction T3 as the end marker transaction as the transaction T3 is the last transaction on Day 3.

At 280, for each transaction assigned a transaction key between a transaction key of the initial marker transaction to, and including, a transaction key of the end marker transaction, the management processor 112 retrieves a latest state generated based on a state change taking place within the predefined period.

Continuing with the example transaction query for the state on Day 3, the management processor 112 can retrieve the state S3, which is the latest state generated based on a state change between the transaction T1 and the transaction T3.

At 290, the management processor 112 can then generate the transaction report based at least on the retrieved latest states. Referring again to the example with the transaction query for the state on Day 3, the management processor 112 can generate the transaction report based on the state S3.

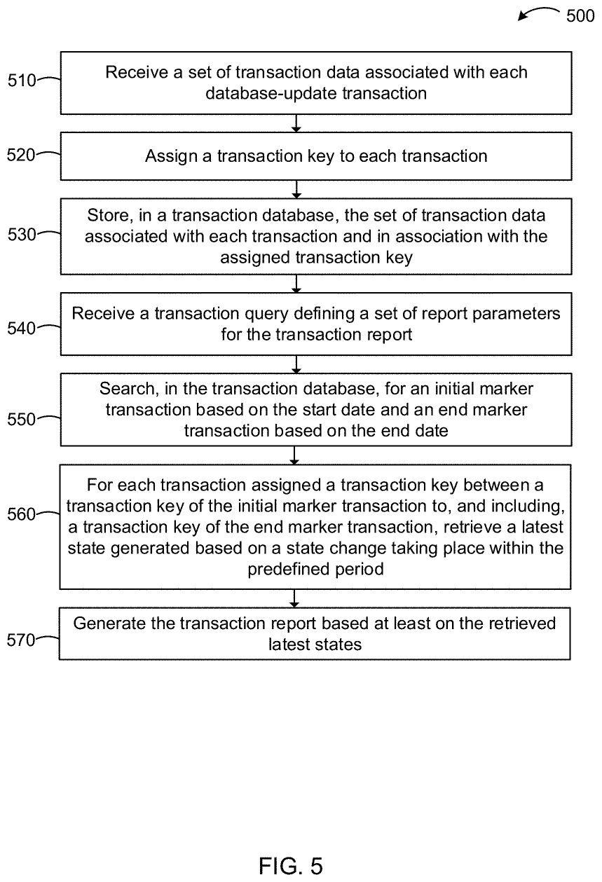

Referring now to FIG. 5, an example method 500 of operating a management processor to generate a transaction report for a predefined period is shown in a flowchart.

At 510, the management processor 112 receives a set of transaction data associated with each database-update transaction.

The management processor 112 can process multiple database-update transactions at any one time. Each database-update transaction can cause an update to one or more states managed by the transaction management system 110. It is possible for the database-update transactions to generate new states, in some embodiments. One transaction can cause one or more states to be updated.

The transaction data can include various information about the transaction, such as an account affected by the transaction, a type of metric being affected by the transaction, an effective date on which the effect is effective, an end date on which the effect is no longer effective, and/or the time when the transaction was processed.

At 520, the management processor 112 assigns a transaction key to each transaction.

Each transaction key can include an ordered value. The ordered value can reflect an execution time of the respective transaction. For example, the management processor 112 can assign a first transaction key to a first transaction and a second transaction key to a second transaction that occurs subsequent to the first transaction. The value of the second transaction key can be subsequent to a value of the first transaction key. The ordered value can, in some embodiments, be monotonically increasing for each subsequently occurring transaction.

At 530, the management processor 112 stores, in the transaction database 116 accessible by the management processor 112, the set of transaction data associated with each transaction and in association with the assigned transaction key.

At 540, the management processor 112 receives a transaction query that defines a set of report parameters for the transaction report.

The set of report parameters includes a start date and an end date of the predefined period. As each state version is stored in the transaction database 116, and/or external database 120, the management processor 112 can retrieve the relevant state version for the time period defined by the transaction query. The management processor 112 can also identify the specific transactions that resulted in the relevant state version, which can, in some embodiments, be important for improving the auditability of the transactions processed by the management processor 112.

An example transaction query can involve requesting a latest state for a metric. For example, the transaction query can request a latest cash balance for an investment account. The transaction query can include the account identifier and state type (e.g., cash in this example). The start and end dates can be unspecified to indicate that the latest balance is being requested, or the end date can be automatically assigned the current date.

As described with respect to the example shown in FIG. 3, the transaction management system 110 can receive a transaction query requesting a state for a metric for a date of interest. The transaction query can include the account identifier and state type (e.g., asset in this example). In some embodiments, a specific product within the state type can be specified. The start and end dates can be assigned the date of interest. In another example, the transaction query can limit the search to locate a state for a metric on a date of interest as of a specific transaction. The transaction query can further include an end transaction.

At 550, the management processor 112 searches, in the transaction database, for an initial marker transaction based on the start date and an end marker transaction based on the end date.

As each transaction is assigned a transaction key with an ordered value, by limiting the search query to transactions assigned a transaction key between the initial marker transaction and the end marker transaction, the management processor 112 can generate the requested transaction report with minimal to no effect on the processing of incoming transactions.

At 560, for each transaction assigned a transaction key between a transaction key of the initial marker transaction to, and including, a transaction key of the end marker transaction, the management processor 112 retrieves a latest state generated based on a state change taking place within the predefined period. At 570, the management processor 112 generates the transaction report based at least on the retrieved latest states.

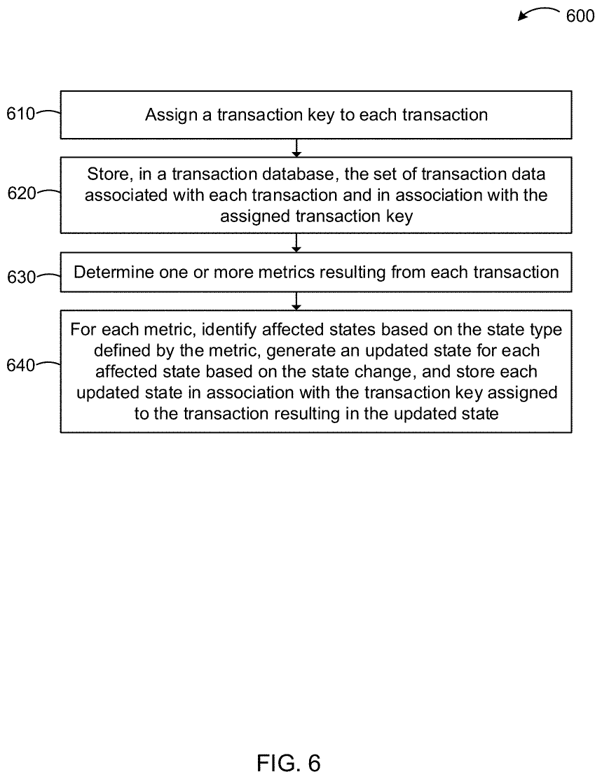

Referring now to FIG. 6, an example method 600 of operating the management processor 112 to selectively retrieve data from a plurality of database-update transactions is shown in a flowchart.

At 610, the management processor 112 assigns a transaction key to each transaction.

Each transaction key can include an ordered value. The ordered value can reflect an execution time of the respective transaction. For example, the management processor 112 can assign a first transaction key to a first transaction and a second transaction key to a second transaction that occurs subsequent to the first transaction. The value of the second transaction key can be subsequent to a value of the first transaction key. The ordered value can, in some embodiments, be monotonically increasing for each subsequently occurring transaction.

At 620, the management processor 112 stores, in a transaction database accessible by the management processor, the set of transaction data associated with each transaction and in association with the assigned transaction key.

At 630, the management processor 112 determines one or more metrics resulting from each transaction.

The metric can identify the affected state types and based on the metric, the management processor 112 can identify the one or more states affected by the metric. The metric can also include information in respect of a start date on which the state change is effective, an end date to the state change, an account affected by the metric, a value of the state change, a start transaction that resulted in the metric, an end transaction that causes the metric to no longer be effective, and the transaction key of the transaction.

It is possible for the metric to not have an end date. The end date may be null if there is no known state change to the affected states. If there are no further updates to the affected state, it is possible for the metric to not have an end transaction.

The metric can also be characterized by a metric type, such as a quantity amount or book value, for example.

At 640, for each metric, the management processor 112, identifies one or more affected states based on the affected state type defined by the respective metric.

The management processor 112 applies the metric to the affected states on the effective date to generate an updated state based on the state change. The management processor 112 can add the state change value to the affected state, in some embodiments.

The management processor 112 stores the updated states in association with the transaction key of the transaction that resulted in the updated state in the transaction database 116. The management processor 112 can also store an update time with the updated state to indicate when the updated state was updated. The management processor 112 can store the updated state as a version of the previously stored state(s) previously stored in the transaction database 116.

In some embodiments, the effective time for a state change resulting from a transaction is at a time in the future. The management processor 112 can determine whether the effective time for a state change has passed. When the management processor 112 determines that the effective time for the state change has passed, the management processor 112 can generate the updated state based on the state change. When the management processor 112 determines that the effective time for the state change has not passed, the management processor 112 can monitor for the passing of the effective time and delay the state change until the effective time has passed.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to herein as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

We claim:

1. A method of operating a management processor to generate a transaction report for a predefined period, the method comprising:
receiving a set of transaction data associated with each transaction of a plurality of database-update transactions;
assigning a transaction key to each transaction, each transaction key comprising an ordered value;
storing, in a transaction database accessible by the management processor, the set of transaction data associated with each transaction and in association with the assigned transaction key;
determining one or more metrics resulting from each transaction, each metric defining a state change to an affected state associated with an affected state type;
for each metric:
identifying one or more affected states based on the affected state type defined by the respective metric, the one or more affected states being associated with a respective state type corresponding to the affected state type defined by the respective metric;
generating an updated state for each affected state based on the state change; and
storing, in the transaction database, each updated state in association with the transaction key assigned to the respective transaction resulting in the updated state;
receiving a transaction query defining a set of report parameters for the transaction report, the set of report parameters comprising a start date and an end date of the predefined period;
searching, in the transaction database, for an initial marker transaction based on the start date and an end marker transaction based on the end date, the initial marker transaction corresponding to a transaction assigned a last transaction key for a day preceding the start date and the end marker transaction corresponding to a transaction assigned a last transaction key for the end date;
for each transaction assigned a transaction key between a transaction key of the initial marker transaction to, and including, a transaction key of the end marker transaction, retrieving a latest state generated based on a state change taking place within the predefined period; and
generating the transaction report based at least on the retrieved latest states.

2. The method of claim 1, wherein the ordered value is reflective of an execution time of the respective transaction.

3. The method of claim 1, wherein assigning the transaction key to each transaction comprises:
assigning a first transaction key to a first transaction of the plurality of database-update transactions; and
assigning a second transaction key to a second transaction occurring subsequent to the first transaction, wherein a value of the second transaction key is subsequent to a value of the first transaction key.

4. The method of claim 1, wherein storing each updated state in association with the transaction key assigned to the respective transaction comprises:
storing the updated state as a version of one or more states previously stored in association with the transaction key.

5. The method of claim 1, wherein storing each updated state in association with the transaction key assigned to the respective transaction comprises:
storing an update time in association with the updated state to indicate when the updated state was updated.

6. The method of claim 14, wherein storing each updated state in association with the transaction key assigned to the respective transactions resulting in the state change to the updated state comprises:
storing an update time in association with the respective updated state, the update time indicating when the updated state was updated.

7. The method of claim 14, wherein generating the updated state for each affected state based on the state change comprises:
determining whether an effective time for the state change has passed; and
in response to determining the effective time for the state change has passed, generating the updated state, otherwise, delaying the state change to each affected state until the effective time has passed.

8. A system of generating a transaction report for a predefined period, the system comprising:
a transaction database for storing transaction data related to a plurality of database-update transactions;
a management processor operable to:
receive a set of transaction data associated with each transaction of the plurality of database-update transactions;
assign a transaction key to each transaction, each transaction key comprising an ordered value;
store, in the transaction database, the set of transaction data associated with each transaction and in association with the assigned transaction key;
determine one or more metrics resulting from each transaction, each metric defining a state change to an affected state associated with an affected state type;
for each metric:
identify one or more affected states based on the affected state type defined by the respective metric, the one or more affected states being associated with a respective state type corresponding to the affected state type defined by the respective metric;
generate an updated state for each affected state based on the state change; and
store, in the transaction database, each updated state in association with the transaction key assigned to the respective transaction resulting in the updated state;
receive a transaction query defining a set of report parameters for the transaction report, the set of report parameters comprising a start date and an end date of the predefined period;
search, in the transaction database, for an initial marker transaction based on the start date and an end marker transaction based on the end date, the initial marker transaction corresponding to a transaction assigned a last transaction key for a day preceding the start date and the end marker transaction corresponding to a transaction assigned a last transaction key for the end date;
for each transaction assigned a transaction key between a transaction key of the initial marker transaction to, and including, a transaction key of the end marker transaction, retrieve a latest state generated based on a state change taking place within the predefined period; and
generate the transaction report based at least on the retrieved latest states.

9. The system of claim 8, wherein the ordered value is reflective of an execution time of the respective transaction.

10. The system of claim 8, wherein the management processor is operated to:
assign a first transaction key to a first transaction of the plurality of database-update transactions; and
assign a second transaction key to a second transaction occurring subsequent to the first transaction, wherein a value of the second transaction key is subsequent to a value of the first transaction key.

11. The system of claim 8, wherein the management processor is operable to:
store the updated state as a version of one or more states previously stored in association with the transaction key.

12. The system of claim 8, wherein the management processor is operable to:
store an update time in association with the updated state to indicate when the updated state was updated.

13. The system of claim 8, wherein the management processor is operable to:
determine whether an effective time for the state change has passed; and
in response to determining the effective time for the state change has passed, generate the updated state, otherwise, delay the state change to each affected state until the effective time has passed.

14. A method of operating a management processor to selectively retrieve data from a plurality of database-update transactions, each transaction having a metric capable of affecting one or more states generated by the management processor, the method comprising:
assigning a transaction key to each transaction, each transaction key comprising an ordered value;
storing, in a transaction database accessible by the management processor and in association with the assigned transaction key, a set of transaction data associated with each transaction;
determining one or more metrics resulting from each transaction, each metric defining a state change to an affected state associated with an affected state type; and
for each metric:
identifying one or more affected states based on the affected state type defined by the respective metric, the one or more affected states being associated with a respective state type corresponding to the affected state type defined by the respective metric;
generating an updated state for each affected state based on the state change; and
storing, in the transaction database, each updated state in association with the transaction key assigned to the respective transaction resulting in the updated state.

15. The method of claim 14, wherein the ordered value is reflective of an execution time of the respective transaction.

16. The method of claim 14, wherein assigning the transaction key to each transaction comprises:
assigning a first transaction key to a first transaction of the plurality of database-update transactions; and
assigning a second transaction key to a second transaction occurring subsequently to the first transaction, wherein a value of the second transaction key is subsequent to a value of the first transaction key.

17. The method of claim 14, wherein storing each updated state in association with the transaction key assigned to the respective transactions comprises:
storing the updated state as a version of one or more states previously stored in association with the transaction key.

18. The method of claim 14, wherein storing each updated state in association with the transaction key assigned to the respective transaction comprises:
storing an update time in association with the updated state to indicate when the updated state was updated.

19. The method of claim 14, wherein storing each updated state in association with the transaction key assigned to the respective transactions resulting in the state change to the updated state comprises:
storing an update time in association with the respective updated state, the update time indicating when the updated state was updated.

20. The method of claim 14, wherein generating the updated state for each affected state based on the state change comprises:
determining whether an effective time for the state change has passed; and
in response to determining the effective time for the state change has passed, generating the updated state, otherwise, delaying the state change to each affected state until the effective time has passed.
